(19) United States
(12) Patent Application Publication
(10) Pub. No.: US 2023/0085272 A1
(43) Pub. Date: Mar. 16, 2023

(54) OPTICAL ELEMENT

(71) Applicant: Galina GEORGIEVA, Berlin (DE)

(72) Inventor: Galina GEORGIEVA, Berlin (DE)

(21) Appl. No.: 17/902,023

(22) Filed: Sep. 2, 2022

(30) Foreign Application Priority Data
Sep. 3, 2021 (EP) 21194821.1

(51) Int. Cl. G02B 6/293

(52) U.S. Cl. CPC G02B 6/29329; G02B 6/2938

(57) ABSTRACT

An embodiment of the present invention relates to an optical element comprising a plurality of perturbing centers arranged in a scattering plane of the optical element. The optical element comprises at least two oriented groups of oriented perturbing centers, wherein a group-individual orientation is assigned to each oriented group, wherein the perturbing centers of each oriented group are oriented in accordance with the same group-individual orientation), and wherein the group-individual orientations are angled relatively to one another. The oriented groups are interweaved. Adjacent perturbing centers belong to different groups and are angled to each other.

### CROSS-REFERENCE TO RELATED APPLICATION

This application claims priority under 35 USC § 119 to European Patent Application No. 21194821.1 filed on Sep. 3, 2021, which is hereby incorporated by reference in their entirety.

### TECHNICAL FIELD

The invention relates to optical elements that comprise a plurality of perturbing centers arranged in a scattering plane.

### BACKGROUND OF THE INVENTION

Modern high-speed communication systems are entirely based on fiber-optic transmission technology. Depending on the link distance, we distinguish between two basic modulation techniques. Long-haul systems rely on spectrally efficient coherent modulation formats, where a signal is coded in amplitude and phase. By contrast, short-reach systems use intensity-modulated direct detection (IM-DD) scheme, in which bits are coded only in the signal amplitude. Currently, the internet traffic growth takes place predominantly in the short-distance inter- or intra-data center interconnect systems, where applications such as video streaming, online meetings, social media, virtual marketplaces etc. are being increasingly used. For that reason, the coherent formats are expected to enter the data center domain, since they allow for a better scalability and power efficiency than the traditional IM-DD.

The largest constraint on the way towards coherent formats for data center interconnects (DCIs) is the total cost of the required systems architecture. Several competing platforms promise for cost reductions by developing on-chip solutions for integrated coherent transmitters and receivers. The highest integration density so-far is offered by silicon photonics. A key advantage hides behind the co-integration of photonics and electronics on existing (Bi)CMOS foundries, by using a mature fabrication process flow. In silicon-based integrated transmitters and receivers, optical in-and out-coupling to a standard single-mode-fiber (SMF) supporting two orthogonal polarizations is advantageous. Optical coupling can face on the one hand issues such as coupling loss, polarization-dependent-loss (PDL), limited bandwidth, excitation of undesired modes, polarization crosstalk and on the other hand fabrication complexity, process variations intolerance, complex packaging and restriction on the wafer-scale characterization. The trade-off between these aspects depends on the coupling scheme of choice.

### OBJECTIVE OF THE PRESENT INVENTION

An objective of the present invention is to provide an optical element with improved optical characteristics.

### SUMMARY OF THE INVENTION

An embodiment of the present invention relates to an optical element comprising a plurality of perturbing centers arranged in a scattering plane of the optical element and configured to effect out-of-plane diffraction of an optical wave propagating in the scattering plane to a diffraction direction having at least two different direction components, one of the direction components being directed perpendicular to the scattering plane. The optical element comprises at least two oriented groups of perturbing centers, wherein a group-individual orientation is assigned to each oriented group. The perturbing centers of each oriented group are oriented in accordance with the same group-individual orientation. The group-individual orientations are angled relatively to one another. An advantage of the above embodiment is that oriented perturbing centers provide additional design options to improve the device's performance. When an optical wave propagates through the optical element's plane, the scattering plane, a part of its power is redirected in nearly vertical direction out of this plane. The latter process is an out-of-plane diffraction and is associated with a propagation direction pointing away from the scattering plane, as governed by the laws of diffraction. In other words, the direction of the diffracted optical wave can be described as having at least two different direction components, one of which being directed perpendicular to the scattering plane. This results in a diffracted wave propagating at an angle to the scattering plane, which may for instance lie in the range between 70° and nearly 90°.

It is noted that, as usual in optics, the above-described configuration is also effective in the opposite direction of propagation. In other words, an incoming out-of-plane optical wave is diffracted to further propagate in-plane, i.e., in the optical element's plane.

In addition, a part of the optical power is scattered inside the optical element's plane: a process, which is called here in-plane scattering. While the out-of-plane diffraction is a desired effect, the in-plane scattering is not desired and in fact limits the light diffraction efficiency for the out-of-plane diffraction. The proposed optical element has two advantageous effects: 1) it ensures a good out-of-plane diffraction efficiency, 2) it suppresses the parasitic, in-plane scattered light.

In-plane scattering is stronger, when there is an array of periodic identical objects, which scatter light in the same in-plane direction. When we use objects (perturbing centers), which scatter light in different directions, a forwards-scattered wave can be compensated by a backwards-scattered wave within the optical element's plane. A precise design of the perturbing centers' dimensions may lead to a complete compensation of forward- and backwards-scattered waves, in particular by use of destructive interference. Oriented perturbing elements such as for instance elliptical or oval perturbing centers instead of or in addition to circular perturbing centers make it possible that adjacent perturbing centers have an abruptly different in-plane scattering pattern. Thus, we may avoid constructive superposition of in-plane scattered light. The reduced in-plane scattered light helps improving the out-of-plane diffraction efficiency.

A further advantage of the above embodiment in comparison with prior-art solutions is that polarizations of out-coupled optical waves are orthogonal to each other over a large range of wavelengths. Prior-art solutions, except for one specific wavelength, transform different input polarizations into non-orthogonal output polarizations.

The angle between adjacent group-individual orientations preferably equals 180° divided by the number of group-individual orientations. For instance, in case of three groups, the angle between adjacent group-individual orientations preferably equals 60°.

A first access side of the optical element may provide a first access port for inputting and/or outputting radiation along a first direction that lies in the scattering plane. The optical element may also have a second access port for inputting and/or outputting radiation along a second direction that differs from the first direction and also lies in the scattering plane.

The arrangement of the perturbing centers in the scattering plane is preferably axially symmetric with respect to the first and second direction. Additionally or alternatively, the arrangement of the perturbing centers in the scattering plane may be axially symmetric with respect to a mirror axis that mirrors the first and second direction with respect to one another.

The first and second direction are preferably angled by an angle between 80° and 90°.

According to a first preferred variant, the perturbing centers may form an array of perturbing centers where the distance is equal.

According to a second preferred variant, the scattering centers may form an array of perturbing centers where the distance between adjacent perturbing centers varies.

According to a third preferred variant, the scattering centers may form an array of perturbing centers where the distance between adjacent perturbing centers is smaller in the array's center than at the array's edge.

According to a fourth preferred variant, the perturbing centers may form an array of perturbing centers where the distance between adjacent perturbing centers increases from the array's center towards the array's edge.

According to a fifth preferred variant, the perturbing centers form different segments. In each segment the perturbing elements are equally sized and at an equal mutual distance. However, the size and mutual distance of the perturbing centers increase with each segment, starting with respective lowest values from any of the access ports and increasing with every next segment at increasing distance from the given access port.

All of the perturbing centers that belong to the same group are preferably identically shaped.

The perturbing centers of the oriented groups are preferably rotationally asymmetric or non-circular.

The oriented perturbing centers are preferably axially symmetric with respect to the group-individual orientation of their group.

All perturbing centers of the oriented groups are preferably identically shaped and/or identically sized.

The oriented perturbing centers are preferably elongated along the respective group-individual orientation.

The perturbing centers of at least one group of perturbing centers are preferably elliptical, or rhombic, or oval.

The optical element preferably also comprises at least one un-oriented group of un-oriented (e. g. symmetric, preferably circular or starlike) perturbing centers.

According to an exemplary embodiment, the optical element comprises a first group of perturbing centers and a second group of perturbing centers, wherein the perturbing centers of the first group are oriented along a first orientation, wherein the perturbing centers of the second group are oriented along a second orientation, and wherein the first orientation and the second orientation are angled by 90°. The optical element preferably also comprises a third group of perturbing elements without any orientation.

According to an another exemplary embodiment, the optical element comprises:
a first group of perturbing centers that are oriented identically,
a second group of perturbing centers that are oriented identically, wherein the orientation of the second group is angled by 45° relatively to the orientation of the first group,
a third group of perturbing centers that are oriented identically, wherein the orientation of the third group is angled by 45° relatively to the orientation of the second group, and angled by 90° relatively to the orientation of the first group, and
a fourth group of perturbing centers that are oriented identically, wherein the orientation of the fourth group is angled by 45° relatively to the orientation of the third group, angled by 90° relatively to the orientation of the second group, and angled by 135° relatively to the orientation of the first group.

The latter embodiment preferably also comprises a fifth group of un-oriented perturbing centers.

The oriented groups of perturbing centers may overlap each other in space such that individual perturbing centers of different groups are arranged in an interweaved manner. For instance, two oriented groups of perturbing centers may overlap in that the individual perturbing centers of the groups are arranged alternately to form pairs of neighboring perturbing centers.

In particular, where there are two interweaved oriented groups, the orientations of neighboring perturbing centers in the direction of propagation of the optical wave may alternate such that the perturbing centers are oriented at non-orthogonal angles with respect to the direction of propagation, wherein the perturbing centers of a given group may all have the same orientation.

Furthermore, where oriented groups of perturbing centers are interweaved, a first interweaved pair of the oriented groups of perturbation centers forms a first segment having a two-dimensional geometrical shape of perturbation centers having at least three edges, the geometrical shape being in particular a rectangular shape or a square shape. A second and any further interweaved pair of the oriented groups of perturbation centers adds a respective angled fringe segment extending the geometrical shape of the first segment along two edges of the first segment. A spatial repetition period of the perturbation centers and a size of the individual perturbation centers decreases with increasing order number of the segments.

A first access side, which provides access from directions out of the optical element's plane may provide an access port for inputting radiation having a first mode with a given polarization state. A second access side of the optical element may provide a first and second access port, which are aligned with the optical element's plane. The perturbing centers are preferably arranged such that each of the latter ports of the second access side outputs radiation having said first polarization and at least a second polarization in response to the radiation that is input at the first access side. The connectivity between the first access side and the two ports of the second access side is enabled by an out-of-plane diffraction.

The optical element may be a polarization multiplexer or de-multiplexer. In the case of a multiplexer, a first access side of the optical element preferably provides a first access port for inputting and/or outputting radiation having a first polarization, and a second access port for inputting and/or outputting radiation having a second polarization that differs from the first polarization. Both ports are aligned with the optical element's plane. A second access side of the optical element preferably provides an access port for inputting and/or outputting radiation of both, the first and second polarization.

The first polarization is preferably perpendicular to the second polarization.

### BRIEF DESCRIPTION OF THE DRAWINGS

In order that the manner in which the above-recited and other advantages of the invention are obtained will be readily understood, a more particular description of the invention briefly described above will be rendered by reference to specific embodiments thereof which are illustrated in the appended drawings. Understanding that these drawings depict only typical embodiments of the invention and are therefore not to be considered to be limiting of its scope, the invention will be described and explained with additional specificity and detail by the use of the accompanying drawings in which:

FIG. 1 illustrates an exemplary embodiment of an optical element where oriented perturbing centers of a perturbing unit are equally spaced and the edges of the perturbing unit form straight lines,

FIG. 2 illustrates the arrangement of the oriented perturbing centers of FIG. 1 in further detail,

FIG. 3 illustrates an alternative arrangement of oriented and un-oriented perturbing centers for the embodiment of FIG. 1,

FIG. 4 illustrates an exemplary embodiment of an optical element where the distance between oriented perturbing centers vary and the edges of the scattering unit are bent,

FIG. 5 illustrates the arrangement of the oriented perturbing centers of FIG. 4 in further detail,

FIG. 6 illustrates an exemplary embodiment of an optical element where a second access side of the optical element outputs radiation with at least two modes in response to single-mode radiation inputted at a first access side,

FIGS. 7-8 illustrate simulation results of the embodiment according to FIGS. 1 and 2,

FIG. 9 illustrates an exemplary embodiment of an SOI waveguide and an exemplary embodiment of a perturbing unit fabricated in SOI-material,

FIG. 10 illustrates a further embodiment of a segmented arrangement of perturbing centers, and

FIG. 11 is an enlarged view of a rectangular section marked in FIG. 10 by a dashed outline.

### DETAILED DESCRIPTION

The preferred embodiments of the present invention will be best understood by reference to the drawings. It will be readily understood that the present invention, as generally described and illustrated in the figures herein, could vary in a wide range. Thus, the following more detailed description of the exemplary embodiments of the present invention, as represented in the figures, is not intended to limit the scope of the invention, as claimed, but is merely representative of presently preferred embodiments of the invention.

In general, when light is incident on an object, two effects can result—diffraction and scattering. Prior art grating couplers are generally considered as diffracting structures only, i.e. it is expected that incident light in the grating plane is completely diffracted out of the grating plane and vice versa. However, when we look at typical two-dimensional grating couplers according to prior art (hereinafter referred to as “prior art 2D GC”), we see that every row consists of discrete elements with sizes smaller than the light spot size of the waveguide mode. For that reason, in-plane scattering will occur in parallel with out-of-plane diffraction. If we have a periodical array of identical objects, the in-plane scattering strength increases due to the identical local in-plane scattering direction and the constructive superposition of the fields scattered by every single element. Thus, in-plane scattered power in a prior art 2D GC is not negligible. There are several consequences of in-plane scattering for prior art 2D GCs. First, increased in-plane scattering reduces the out-of-plane diffraction efficiency. Therefore, the prior art 2D GCs suffer from higher insertion loss. Second, in-plane scattering is able to convert the polarization of an incident wave, which explains the high cross-polarization in prior art 2D GCs. Cross-polarization is inevitably related to polarization crosstalk and can cause that initially orthogonal polarizations become non-orthogonal. Third, the cross-polarization causes higher-order mode coupling, because of its field distribution. In single-mode waveguides, the higher-order modes will be filtered, which leads again to higher insertion loss. Fourth, due to the random polarization rotation in a SMF cross-polarization in the waveguides is not necessarily in phase with the target signal's polarization. Superposition of target- and cross-polarization with different phase relations in the two waveguides can lead to significant PDL.

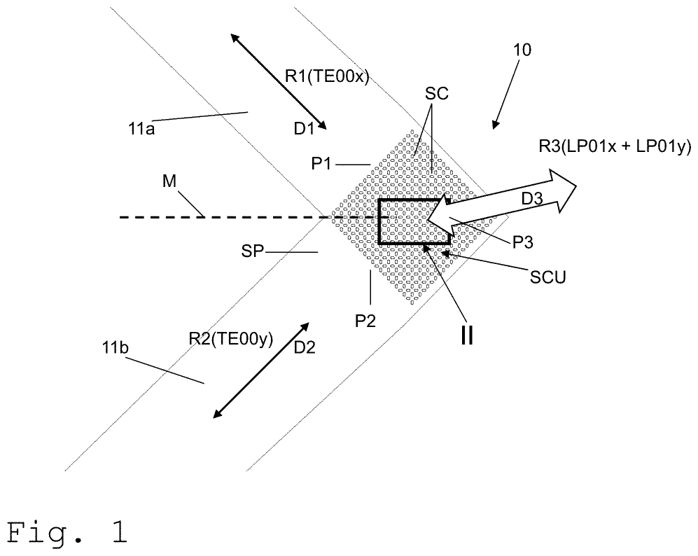

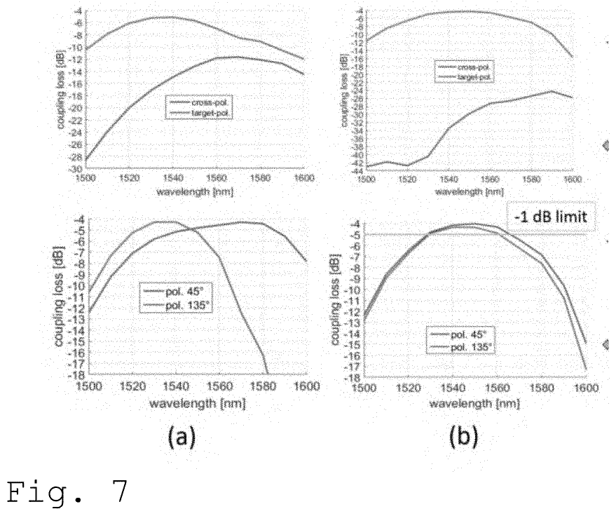

In connection with FIGS. 1-9, exemplary embodiments of optical elements will be presented that mitigate the above deficiencies and problems, for instance in the following way: In-plane scattering is stronger, when we have an array of periodic identical objects with an identical local in-plane scattering profile. When we use objects (perturbing centers), which scatter light in different in-plane directions, a forwards-scattered wave can be compensated by a backwards-scattered wave. A precise design of the perturbing centers' dimensions may lead to a complete compensation of forwards- and backwards-scattered waves. To realize this principle, we use as perturbing centers elliptical instead of or in addition to circular perturbing centers. When we change the ellipses orientation along the grating axes, we can ensure that adjacent objects have an abruptly different local in-plane scattering profile. Thus, we avoid constructive superposition of in-plane scattered light. The suppression of the parasitic in-plane scattered fields can enhance the out-of-plane diffraction efficiency.

FIG. 1 depicts a first exemplary embodiment of an optical element 10 according to the present invention. The optical element 10 forms a two-dimensional grating coupler and comprises a plurality of perturbing centers SC that are arranged in a scattering plane SP of the optical element 10 and together form a perturbing unit SCU. A first waveguide 11a and a second waveguide 11b are connected to the perturbing unit SCU.

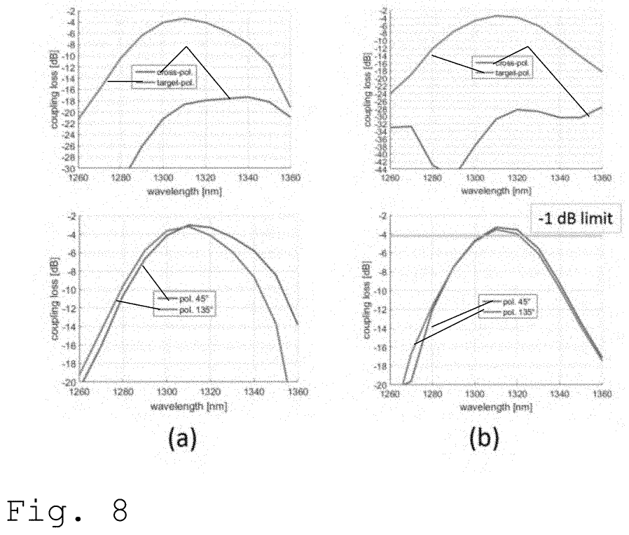

The waveguides 11a and 11b are preferably SOI (silicon-on-insulator) ridge waveguides. The perturbing centers SC are preferably formed by holes etched inside the upper silicon layer 12 of the SOI material. FIG. 9 shows an exemplary embodiment of a cross section of the first waveguide 11a and a cross section of a portion of the perturbing unit SCU. Reference numeral 13 indicates the SiO2 layer of the SOI material and reference numeral 14 indicates the substrate of the SOI material.

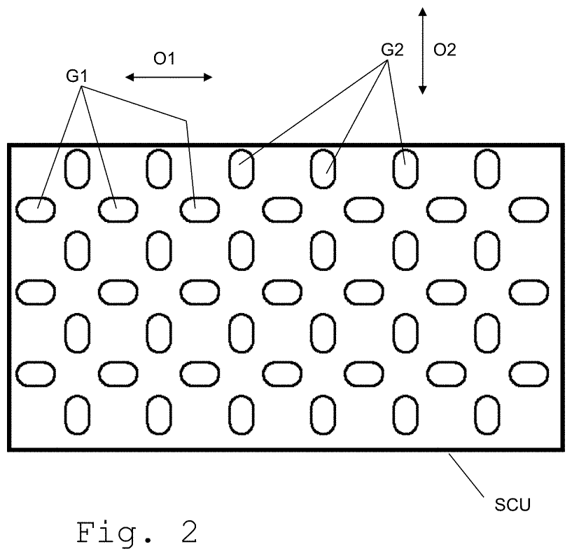

FIG. 2 visualizes section II of FIG. 1 and the arrangement of the perturbing centers SC in further detail.

The embodiment of FIGS. 1 and 2 comprises a first group G1 of perturbing centers SC that are oval and oriented horizontally (with respect to their longitudinal axis and the page's orientation of FIG. 1). The group-individual orientation of the first group G1 corresponds to the longitudinal axis of the oval perturbing centers and is marked by a left right arrow O1 in FIG. 2.

The perturbing centers SC of a second group G2 are also oval but oriented vertically (again with respect to their longitudinal axis and the page's orientation of FIG. 1). In other words, the perturbing centers SC of both groups G1 and G2 are not circular and their group-orientation is perpendicular relatively to one another. The group-individual orientation of the second group G2 corresponds to the longitudinal axis of the oval perturbing centers and is marked by an up down arrow O2 in FIG. 2. In addition, both oriented groups of perturbing centers are interweaved.

In the exemplary embodiment of FIG. 1, the perturbing centers SC of both groups G1 and G2 are axially symmetric with respect to both their longitudinal axis as well as their group-individual orientation O1 and O2.

The optical element 10 of FIG. 1 comprises a first access port P1 which is connected to the waveguide 11a. The first access port P1 allows inputting and/or outputting radiation R1 along a first direction D1 that lies in the scattering plane SP.

A second access port P2 of the optical element 10 of FIG. 1 is connected to the waveguide 11b and allows inputting and/or outputting radiation R2 along a second direction D2 that is angled by an angle between 80° and 90° with respect to the first direction D1. The second direction D2 also lies in the scattering plane SP.

The arrangement of the perturbing centers SC in the scattering plane SP is axially symmetric with respect to a mirror axis M that mirrors the first and second direction D1 and D2 with respect to one another. In the exemplary embodiment of FIG. 1, the arrangement of the scattering centers SC in the scattering plane SP is also axially symmetric with respect to both the first and second direction D1 and D2.

A third access port P3 of the optical element 10 of FIG. 1 allows inputting and/or outputting radiation R3 along a third direction D3 that is angled by an angle between 70° and 90° with respect to the scattering plane SP. In other words, in the exemplary embodiment of FIG. 1, the third direction D3 is approximately perpendicular to the page's plane of FIG. 1.

As depicted in an exemplary fashion in FIG. 1, radiation R3 may be inputted at the third access port P3. Radiation R3 may comprise a first portion with LP01x-mode and X-polarization as well as a second portion with LP01y-mode and Y-polarization.

The perturbing centers SC may transform the electromagnetic fields such that the first access port P1 outputs radiation with TE00x-mode and X-polarization. The second access port P2 outputs radiation in TE00y-mode and with Y-polarization. X and Y refer to coordinates of a x-y-z-coordinate system.

Of course, the optical element 10 of FIG. 1 may be operated inversely by inputting radiation with a TE00x mode at the first access port P1 and inputting radiation R2 with a TE00y-mode at the second access port P2. Then, the perturbing centers SC may transform the electromagnetic fields such that the third access port P3 outputs the radiation R3 with both LP01x-mode and LP01y-mode.

In other words, the optical element 10 may operate as a polarization multiplexer or de-multiplexer in both directions.

The angle between the two group-individual orientations O1 and O2 preferably equals 180° divided by the number of group-individual orientations. If the embodiment of FIG. 1 comprised three or more groups of perturbing centers SC and therefore three or more group-individual orientations instead of two, the angle between adjacent group-individual orientations would preferably equal 180° divided by the number of group-individual orientations.

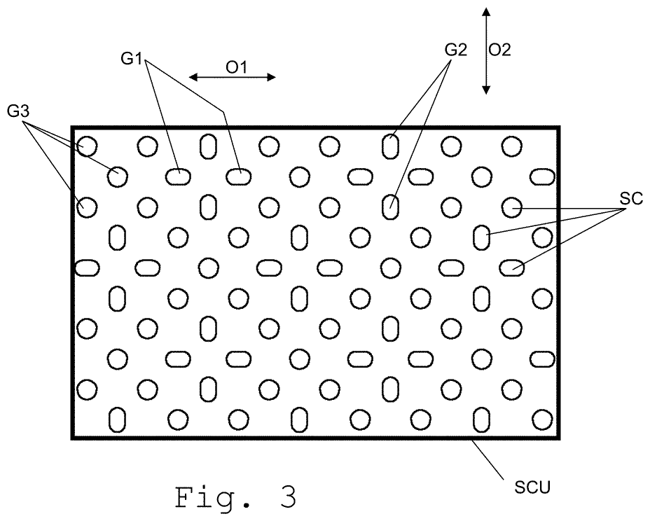

FIG. 3 depicts another exemplary arrangement of perturbing centers SC in the scattering plane SP. The perturbing centers SC of FIG. 3 form a perturbing unit SCU that can be integrated in the optical element 10 of FIG. 1 in order to replace the perturbing unit SCU depicted in FIG. 2.

The perturbing unit SCU of FIG. 3 comprises a first group G1 of perturbing centers SC that are oriented horizontally (with respect to the page's orientation of FIG. 1), a second group G2 of perturbing centers SC that are oriented vertically, and an un-oriented group G3 that comprises circular perturbing centers SC. The perturbing centers SC of the first and second group G1 and G2 may be identically to the perturbing centers SC of the first and second group G1 and G2 of FIGS. 1 and 2. The three groups of perturbing elements are interweaved.

The concentration and arrangement of the circular perturbing centers SC influences the conversion of radiation with respect to the modes. Therefore, the circular perturbing centers SC may be added to achieve other conversion behaviors than the one discussed above with reference to FIGS. 1 and 2.

The exemplary embodiment according to FIGS. 1 and 2 has been subjected to a numerical analysis based on a finite-integration-technique time-domain method by the commercial Simulia CST.

The following table lists the geometric details and simulation results regarding a reference 2D GC (with only circular holes), and the proposed optical element according to FIGS. 1 and 2 with elliptical holes. Both structures are designed for C-band.

| | Reference 2D GC | Proposed 2D GC |
|---|---|---|
| Geometric | with circular | according to |
| Properties | holes only | FIGS. 1 and 2 |
| Grating period | 622 nm | 594 nm |
| Shear angle | 2° | 2° |
| Etch depth | 120 nm | 140 nm |
| Holes shape | Circular: | Elliptic: |
| | diameter = | short side = 230 nm, |
| | 440 nm | long side = 320 nm |

The following table lists the geometric details and simulation results regarding a reference 2D GC (with only circular holes), and the proposed optical element according to FIGS. 1 and 2 with elliptical holes. Both structures are designed for O-band.

| | Reference 2D GC | Proposed 2D GC |
|---|---|---|
| Geometric | with circular | according to |
| properties | holes only | FIGS. 1 and 2 |
| Grating period | 485 nm | 480 nm |
| Shear angle | 2° | 2° |
| Etch depth | 120 nm | 140 nm |
| Holes shape | Circular: | Elliptic: |
| | diameter = | short side = 180 nm, |
| | 280 nm | long side = 260 nm |

The simulation results are shown in FIG. 8 (a) and (b) for C-band and FIG. 9 (a) and (b) for O-band.

The reference structure and the proposed structure according to FIGS. 1 and 2 differ little in terms of insertion loss and bandwidth. While standard designs show a strong cross-polarization, inevitably leading to a large PDL, the proposed design perform significantly better, reaching values acceptable for the target applications. The reduced cross-polarization and polarization crosstalk and the almost ideal polarizations' orthogonality will require no compensation for certain coherent modulation formats. More important is the significant improvement in terms of PDL. The latter greatly degrades the receiver performance and cannot be compensated by digital signal processing.

The following table lists performance results regarding the reference 2D GC with only circular holes, and the proposed optical element according to FIGS. 1 and 2 with elliptical holes, as designed for C-band.

| | | |
|---|---|---|
| | Reference 2D GC | |
| Performance | with circular | Proposed |
| benchmarks | holes only | 2D GC |

| | | | | |
|---|---|---|---|---|
| Insertion loss | 4.4 | dB | 4.1 | dB |
| 1 dB bandwidth | 30 | nm | 37 | nm |
| Bandwidth with | <10 | nm | 57.5 | nm |
| PDL < 0.5 dB | | | | |
| Max. PDL within | 1.7 | dB | 0.55 | dB |
| the 1 dB bandwidth | | | | |

| | | |
|---|---|---|
| Absolute | ~30° | <3° |
| orthogonality | | |
| deviation within | | |
| the 1 dB bandwidth | | |

The following table lists performance results regarding the reference 2D GC with only circular holes, and the proposed optical element according to FIGS. 1 and 2 with elliptical holes, as designed for O-band.

| | | |
|---|---|---|
| | Reference 2D GC | |
| Performance | with circular | Proposed |
| benchmarks | holes only | 2D GC |

| | | | | |
|---|---|---|---|---|
| Insertion loss | 3 | dB | 3.2 | dB |
| 1 dB bandwidth | 25 | nm | 22 | nm |
| Bandwidth with | <15 | nm | 80 | nm |
| PDL < 0.5 dB | | | | |
| Max. PDL within | 1.2 | dB | 0.5 | dB |
| the 1 dB bandwidth | | | | |

| | | |
|---|---|---|
| Absolute | ~12° | <3° |
| orthogonality | | |
| deviation within | | |
| the 1 dB bandwidth | | |

In the exemplary embodiment of FIGS. 1 and 2, the distance between the adjacent perturbing centers SC is equal in the entire perturbing unit.

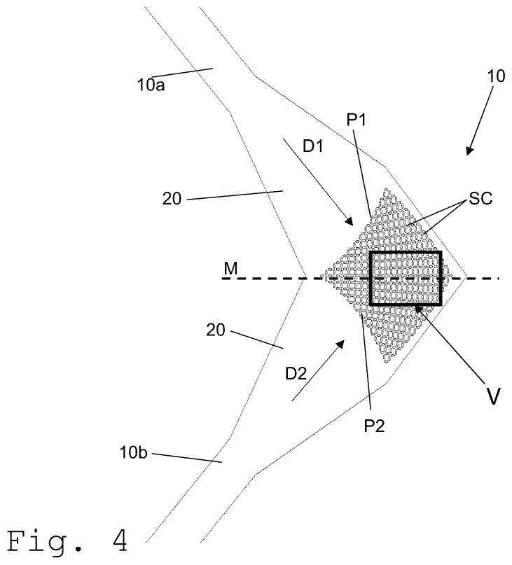

FIG. 4 depicts a second exemplary embodiment of an optical element 10 according to the present invention. In contrast to FIGS. 1-3, the distance between adjacent perturbing centers SC varies. More specifically, in the exemplary embodiment of

FIG. 4, the perturbing centers SC form an array of perturbing centers SC where the distance between adjacent perturbing centers SC decreases from the access ports P1 and P2 towards the array's middle section.

Furthermore, the array's edges are circularly bent at the access ports P1 and P2 in order to enable mode coupling via shorter adjacent tapers 20.

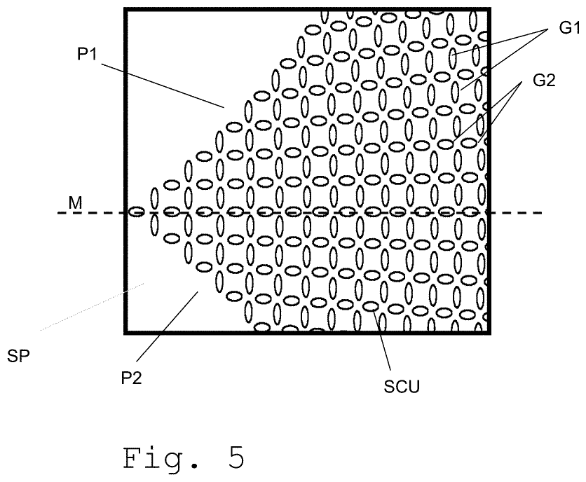

FIG. 5 visualizes section V of FIG. 4 and the arrangement of the perturbing centers SC in further detail. The arrangement of the perturbing centers SC in the perturbing plane SP is again axially symmetric with respect to the mirror axis M that mirrors the first and second direction D1 and D2 with respect to one another. However, due to the bent edges of the perturbing unit SCU, the arrangement of the perturbing centers SC is axially asymmetric with respect to the first and/or second direction D1 and D2.

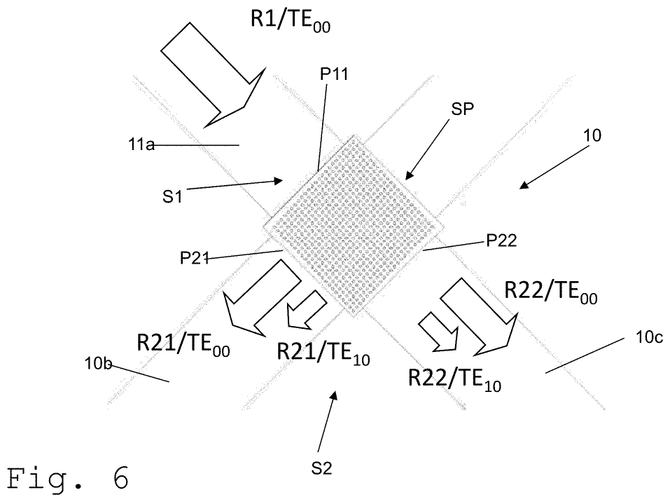

FIG. 6 depicts a third exemplary embodiment of an optical element 10 according to the present invention. This time, the in-plane scattering manipulation is not used to enhance the out-of-plane diffraction. Instead, the in-plane scattering is used to transform a given waveguide mode and polarization into a combination of waveguide modes and polarizations, coupled to other two output ports. All access ports are in the same plane.

On a first access side S1 of the optical element 10, an access port P11 is connected to a waveguide 11a. The access port P11 allows inputting radiation R11 with a first mode. In the exemplary embodiment of FIG. 6, the first mode is a TE00-mode.

A second access side S2 of the optical element 10 provides a first access port P21 and second access port P22. Each of the latter ports P21 and P22 outputs radiation R21/R22 that comprises the first mode, e. g. said TE00-mode, and at least a second mode in response to the radiation R11 that is inputted at the first access side S1. In the exemplary embodiment of FIG. 6, the second mode is a TE10-mode.

The ports P21 and P22 are connected to waveguides 10b and 10c. The waveguides 10a, 10b, and 10c as well as the perturbing centers SC lie in the scattering plane SP.

The size, orientation and arrangement of perturbing centers SC determines the conversion and the conversion ratios of the modes. The different sizes of the arrows in FIG. 6 indicate that the amplitude of the TE10-mode may be smaller than the amplitude of the TE00-mode at the second access side S2.

The optical elements 10 described above in connection with FIGS. 1-9 can be fabricated based on 248 nm photolithography, which is significantly cheaper than a 193 nm photolithography or e-beam lithography.

The perturbing centers SC discussed above in the context of the exemplary embodiments of FIGS. 1 to 5 may be used to minimize the parasitic in-plane scattered power at integrated receiver or transmitter interfaces, ensuring an efficient coupling in optical waveguides by diffraction. Undesired effects such as higher-order modes excitation, PDL, polarization crosstalk and polarizations' non-orthogonality may be minimized.

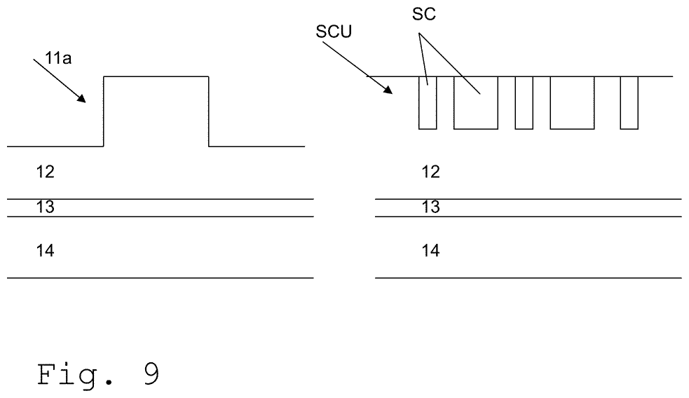

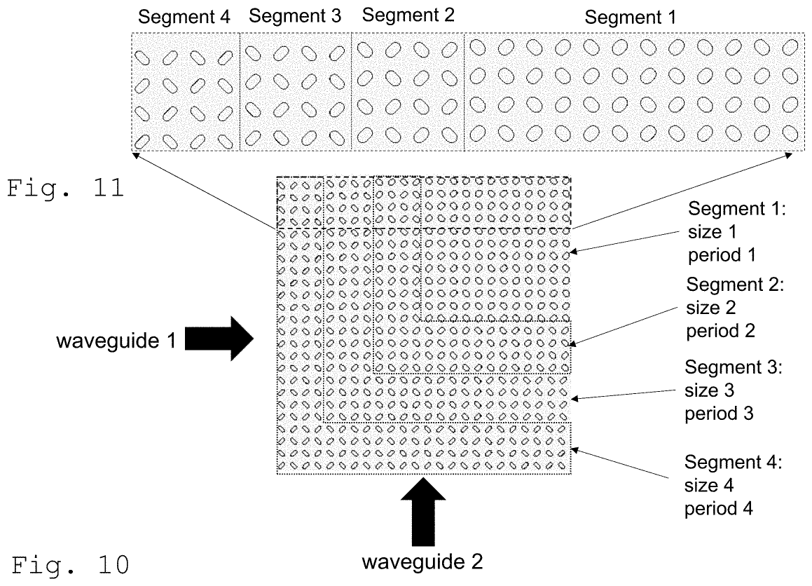

FIG. 10 illustrates a further embodiment, where oriented groups of perturbing centers are interweaved. FIG. 11 is an enlarged view of a rectangular section marked in FIG. 10. In particular, a first interweaved pair of the oriented groups of perturbation centers forms a first segment labeled Segment 1. The Segment 1 has a square shape. A second segment Segment 2 of interweaved pairs of the oriented groups of perturbation centers adds an angled fringe segment extending the square shape of the Segment 1 along two of its edges, to form a larger square comprising four oriented groups altogether. A spatial repetition frequency of the perturbation centers, represented by a repetition period Period 2 (which is the inverse of the repetition frequency) and a size (Size 2) of the individual perturbation centers in Segment 2 is smaller than corresponding values Period 1, Size 1 in Segment 1. Different sizes are associated with different local perturbation strengths, providing further flexibility for the manipulation of in-plane scattering and out-of-plane diffraction. This formation principle is repeated by two further segments, labeled Segment 3 and Segment 4, which have decreasing sizes and spatial frequencies with increasing order number of the segments, Segment 3 and Segment 4. The segmented configuration can be formed using un-oriented perturbing centers as well. Optical access waveguides are placed at both longer sides of the last segment.

The exemplary embodiments described above in connection with FIGS. 1-11 1-5, 7-10 are based on silicon photonic 2D grating couplers used as coupling structures. The principle can be used in other coupling structures or on other material platforms as well. FIG. 6 illustrates an on-chip mode and/or polarization converter. The examples cope with passive components, but the principle can be applied to active elements as well. The major advantage of the proposed use of perturbing centers compared to other solutions is the reduced fabrication complexity regarding the required minimum features dimensions. With this, even low-resolution lithographic techniques such as 248 nm deep UV lithography can be used for the fabrication, which allows for large-scale cost-effective fabrication.

The various embodiments and aspects of embodiments of the invention disclosed herein are to be understood not only in the order and context specifically described in this specification, but to include any order and any combination thereof. Whenever the context requires, all words used in the singular number shall be deemed to include the plural and vice versa. Whenever the context requires, all options that are listed with the word “and” shall be deemed to include the word “or” and vice versa, and any combination thereof.

In the drawings and specification, there have been disclosed a plurality of embodiments of the present invention. The applicant would like to emphasize that each feature of each embodiment may be combined with or added to any other of the embodiments in order to modify the respective embodiment and create additional embodiments. These additional embodiments form a part of the present disclosure and, therefore, the applicant may file further patent claims regarding these additional embodiments at a later stage of the prosecution.

Further, the applicant would like to emphasize that each feature of each of the following dependent claims may be combined with any of the present independent claims as well as with any other (one or more) of the present dependent claims (regardless of the present claim structure). Therefore, the applicant may direct further patent claims towards other claim combinations at a later stage of the prosecution.

What is claimed is:

1. An optical element comprising a plurality of perturbing centers arranged in a scattering plane of the optical element and configured to effect out-of-plane diffraction of an optical wave propagating in the scattering plane to a diffraction direction having at least two different direction components, one of the direction components being directed perpendicular to the scattering plane,
characterized in that
the optical element comprises at least two oriented groups of oriented perturbing centers,
wherein a group-individual orientation is assigned to each oriented group,
wherein the perturbing centers of each oriented group are oriented in accordance with the same group-individual orientation, and
wherein the group-individual orientations are angled relatively to one another, adjacent perturbing centers belonging to different groups having different orientations.

2. The optical element according to claim 1, characterized in that the angle between adjacent group-individual orientations equals 180° divided by the number of group-individual orientations.

3. The optical element according to claim 2, characterized in that
a first access side of the optical element provides a first access port for inputting and/or outputting radiation along a first direction that lies in the scattering plane, and a second access port for inputting and/or outputting radiation along a second direction that differs from the first direction and also lies in the scattering plane,
wherein the arrangement of the perturbing centers in said scattering plane is axially symmetric with respect to the first and second direction.

4. The optical element according to claim 1, characterized in that
the optical element comprises a first access port for inputting and/or outputting radiation along a first direction that lies in the scattering plane, and a second access port for inputting and/or outputting radiation along a second direction that is angled by an angle between 80° and 90° to the first direction and also lies in the scattering plane,
wherein the arrangement of the perturbing centers in said scattering plane is axially symmetric with respect to a mirror axis that mirrors the first and second direction with respect to one another.

5. The optical element according to claim 1, characterized in that the perturbing centers form an array of perturbing centers where the distance between adjacent perturbing centers increases from the array's center towards the array's edge.

6. The optical element according to claim 1, characterized in that all of the perturbing centers that belong to the same group are identically shaped and/or sized.

7. The optical element according to claim 1, characterized in that the perturbing centers of the oriented groups are rotationally asymmetric.

8. The optical element according to claim 1, characterized in that the perturbing centers of the oriented groups are axially symmetric with respect to the group-individual orientation of their group.

9. The optical element according to claim 1, characterized in that all perturbing centers of the oriented groups are identically shaped and/or identically sized.

10. The optical element according to claim 1, characterized in that the perturbing centers of the oriented groups are elongated along the respective group-individual orientation.

11. The optical element according to claim 1, characterized in that the perturbing centers of the oriented groups comprise perturbing centers of an elliptical or oval shape.

12. The optical element according to claim 1, characterized in that the optical element further comprises at least one unoriented group of unoriented perturbing centers.

13. The optical element according to claim 1, characterized in that the optical element comprises at least one group of circular perturbing centers.

14. The optical element according to claim 1, characterized in that
the optical element comprises a first group of perturbing centers and a second group of perturbing centers,
wherein the perturbing centers of the first group are oriented along a first orientation,
wherein the perturbing centers of the second group are oriented along a second orientation, and
wherein the first orientation and the second orientation are angled by 90°.

15. The optical element according to claim 1, characterized in that
a first access side of the optical element provides an access port for inputting radiation having a first mode, and
a second access side of the optical element provides a first and second access port each of which outputs radiation having the first mode and at least a second mode in response to the radiation that is inputted at the first access side.

16. The optical element according to claim 1, characterized in that
the optical element is a polarization multiplexer,
wherein the optical element provides a first access port for inputting and/or outputting radiation having a first polarization, and a second access port for inputting and/or outputting radiation having a second polarization that differs from the first polarization, and
wherein the optical element provides a third access port for inputting and/or outputting radiation that has both, the first and second polarization.

17. The optical element according to claim 1, characterized in that
the oriented groups overlap in space such that individual perturbing centers of different groups are interweaved.

18. The optical element according to claim 17, characterized in that
there are two interweaved oriented groups,
the orientations of neighboring perturbing centers in the direction of propagation of the optical wave alternate and are at non-orthogonal angles with respect to the direction of propagation, and in that
the perturbing centers of a given group all have the same orientation.

19. The optical element according to claim 17, characterized in that
a first interweaved pair of the oriented groups of perturbation centers forms a first segment having a two-dimensional geometrical shape of perturbation centers having at least three edges, the geometrical shape being in particular a rectangular shape or a square shape,
a second and any further interweaved pair of the oriented groups of perturbation centers adds an angled fringe segment extending the geometrical shape of the first segment along two edges of the first segment, wherein
a spatial repetition period of the perturbation centers and a size of the individual perturbation centers decreases with increasing order number of the segments.

20. The optical element according to claim 1, characterized in that
a first access side of the optical element provides a first access port for inputting and/or outputting radiation along a first direction that lies in the scattering plane, and a second access port for inputting and/or outputting radiation along a second direction that differs from the first direction and also lies in the scattering plane,
wherein the arrangement of the perturbing centers in said scattering plane is axially symmetric with respect to the first and second direction.

21. The optical element according to claim 1, characterized in that
the optical element is a polarization de-multiplexer,
wherein the optical element provides a first access port for inputting and/or outputting radiation having a first polarization, and a second access port for inputting and/or outputting radiation having a second polarization that differs from the first polarization, and
wherein the optical element provides a third access port for inputting and/or outputting radiation that has both, the first and second polarization.
